(19) United States
(12) Patent Application Publication
(10) Pub. No.: US 2004/0202921 A1
(43) Pub. Date: Oct. 14, 2004

(54) Apparatus and method for addition of electrolyte to fuel cells

(75) Inventor: Jeffrey Peter Allen, Naugatuck, CT (US)

Correspondence Address: BANNER & WITCOFF, LTD., 28 STATE STREET, 28th FLOOR, BOSTON, MA, 02109-9601, US

(73) Assignee: GenCell Corporation, Southbury, CT (US)

(21) Appl. No.: 10/808,684

(22) Filed: Mar. 25, 2004

Related U.S. Application Data
(60) Provisional application No. 60/462,645, filed on Apr. 14, 2003.

(51) Int. Cl. H01M 2/36; H01M 8/04; H01M 8/14; H01M 2/12

(52) U.S. Cl. 429/80; 429/82; 429/26; 429/46

(57) ABSTRACT

An electrolyte delivery apparatus that includes an electrolyte reservoir, a heating device and a pressure generator is provided. The electrolyte delivery apparatus is configured to supply electrolyte to a fuel cell, such as a molten carbonate fuel cell, or fuel cell stack, and, in certain examples, to an operating fuel cell or fuel cell stack. A fuel cell assembly including the electrolyte delivery apparatus and methods of using the electrolyte delivery apparatus are also provided.

### PRIORITY CLAIM

This application claims the benefit of U.S. Provisional Application No. 60/462,645 filed on Apr. 14, 2003 and entitled “Method and Apparatus for Addition of Molten Carbonate Electrolyte to an Operating Molten Carbonate Fuel Cell,” the entire disclosure of which is hereby incorporated herein by reference for all purposes.

### FIELD OF THE INVENTION

This invention relates to electrochemical fuel cells and to methods of using them. More particularly, this invention relates to methods and apparatus for the addition of electrolyte, such as molten carbonate electrolyte, to fuel cells.

### BACKGROUND

Fuel cells are electrochemical devices that produce direct electric current and thermal energy. Fuel cell stacks are comprised of a plurality of fuel cells stacked in a series relationship to achieve higher useable voltage output capacities.

Fuel cells are generally identified by the type of electrolyte that is used. For example, molten carbonate fuel cells (MCFCs) may use a mixture of lithium carbonate and potassium carbonate as the electrolyte. Phosphoric acid fuel cells (PAFCs) may use phosphoric acid solutions as an electrolyte. Polymer electrolyte fuel cells (PEFCs) may use a polymer such as Nafion®, a product of Dupont de Numers Corporation, as an electrolyte. Solid oxide fuel cells (SOFCs) may use a yittria-stabilized zirconia as an electrolyte.

For fuel cells that utilize a liquid-phase electrolyte, depletion of the electrolyte inventory below a level necessary to partly saturate the pore volume of the fuel cell electrodes can result in diminished catalysis and reduced electrochemical performance of the fuel cell. There is a need in the art for an apparatus to replenish fuel cell electrolytes, and in particular, there is a need in the art for an apparatus to replenish liquid-phase fuel cell electrolytes in an operating fuel cell or fuel cell stack.

It is an object of the present invention to provide an apparatus and methods to replenish electrolyte of a fuel cell and/or electrolyte of a plurality of fuel cells, such as those in a fuel cell stack. It is a particular object of certain examples or embodiments to provide an apparatus and methods to replenish electrolyte of a fuel cell or fuel cells in a fuel cell stack during operation of the fuel cell(s).

### SUMMARY OF THE INVENTION

In accordance with a first aspect, an electrolyte delivery apparatus is disclosed. The electrolyte delivery apparatus is configured to provide electrolyte to a fuel cell, e.g., an operating fuel cell, or to fuel cells in a fuel cell stack, for example. The electrolyte delivery apparatus includes at least an electrolyte reservoir, a fluid conduit that receives electrolyte from the electrolyte reservoir, a heating device and a pressure generator. The electrolyte reservoir and fluid conduit are configured to provide electrolyte to the fuel cell or the fuel cell stack. The heating device is in thermal communication with at least a portion of the electrolyte reservoir and/or fluid conduit and is operative to increase the fluidity of the electrolyte, or liquify the electrolyte in the case of solid electrolyte, in the electrolyte reservoir and/or fluid conduit. The pressure generator is operative to force fluid out of the electrolyte reservoir and into the fluid conduit for delivery to the fuel cell or the fuel cell stack. The electrolyte delivery apparatus disclosed here provides advantages including semi-continuous or continuous supply of electrolyte to an individual fuel cell, e.g., to a non-operating or operating fuel cell or a fuel cell stack. Such semi-continuous or continuous supply of electrolyte can increase the efficiency of the fuel cell or fuel cell stack.

In accordance with another aspect, a fuel cell assembly is disclosed. The fuel cell assembly comprises a fuel cell, an electrolyte reservoir, a fluid conduit, and a heating device. The fuel cell of the fuel cell assembly includes a cathode electrode, an anode electrode and an electrolyte matrix between the cathode electrode and anode electrode. The electrolyte reservoir is in fluid communication with a fluid conduit that provides fluid communication between the electrolyte reservoir and the fuel cell to deliver electrolyte to the fuel cell. The electrolyte reservoir includes one or more electrolytes, e.g., one or more solid or liquid electrolytes, and preferably the same electrolyte as between the cathode and anode of the fuel cell. The heating device is in thermal communication with the electrolyte reservoir and/or the fluid conduit, to heat electrolyte in the fluid conduit and/or the electrolyte reservoir and is operative to increase the fluidity of electrolyte, or to provide liquid electrolyte, for delivery to the fuel cell. The fuel cell assembly may also include a pressure generator that is configured to force fluid from the electrolyte reservoir and into the fuel cell through the fluid conduit.

In accordance with an additional aspect, a method of supplying electrolyte to a fuel cell is disclosed. The method includes replacing lost electrolyte from a fuel cell by providing an electrolyte reservoir comprising electrolyte, heating the electrolyte reservoir to increase fluidity of at least a portion of the electrolyte and delivering fluid from the electrolyte reservoir to a fuel cell. The electrolyte reservoir is in fluid communication with the fuel cell through a fluid conduit that connects the electrolyte reservoir and the fuel cell. The fluid from the electrolyte reservoir may be delivered to the fuel cell, for example, by pressurizing the electrolyte reservoir which forces fluid out of the electrolyte reservoir, through the fluid conduit and into the fuel cell. Other exemplary suitable methods for delivery of the electrolyte from the electrolyte reservoir to the fuel cell are discussed below.

It will be recognized by the person of ordinary skill in the art, given the benefit of this disclosure, that the electrolyte delivery apparatus, fuel cell assembly and methods of using them provides numerous advantages including, but not limited to, maintaining a substantially constant supply of electrolyte in an operating fuel cell or fuel cell stack to provide more efficient fuel cells and fuel cell stacks.

### BRIEF DESCRIPTION OF THE DRAWINGS

Certain illustrative aspects and examples are described below with reference to the accompanying drawings, in which:

FIG. 1 is a perspective view of yet another exemplary fuel cell assembly including a fuel cell stack and electrolyte delivery apparatus that includes pressure-regulated gas, in accordance with certain examples; and

FIG. 2 is a diagram of a porous conduit in physical contact with, and in fluid communication with, multiple fuel cells in a fuel cell stack.

It will be recognized by the person of ordinary skill in the art, given the benefit of this disclosure, that the figures, and components thereof, are not necessarily to scale and certain components shown in the figures may be exaggerated, distorted or enlarged relative to other components to facilitate a better understanding of the exemplary aspects and examples of the invention that are discussed in detail below.

### DETAILED DESCRIPTION OF CERTAIN EXAMPLES

The electrolyte delivery apparatus, fuel cell assemblies including the electrolyte delivery apparatus, and methods of using the electrolyte delivery apparatus represent a significant technological advance. Electrolyte levels can be maintained substantially constant using the devices disclosed here even during operation of the fuel cell or fuel cell stack. Such substantially constant electrolyte levels provide significant benefit including, for example, operation of the fuel cells at high capacity without undesirable loss of efficiency due to electrolyte loss.

In accordance with certain examples, an electrolyte delivery apparatus which includes an electrolyte reservoir and a fluid conduit is disclosed. The electrolyte reservoir holds fluid(s) comprising electrolyte for delivery to a fuel cell in fluid communication with the electrolyte reservoir through the fluid conduit. In certain examples, the electrolyte to be delivered has substantially the same composition as the electrolyte that is used in the operating fuel cell.

In accordance with certain examples, the electrolyte delivery apparatus, and components thereof, may take numerous shapes, dimensions, etc. depending on the use environment of the fuel cell that the electrolyte delivery apparatus is in fluid communication with. In certain examples, the electrolyte reservoir of the electrolyte delivery apparatus is of suitable dimensions to hold about 1 L to about 5 L of fluid. According to certain examples, the electrolyte reservoir is positioned such that the level of the electrolyte stored within the reservoir is physically below the point where the fluid conduit terminates within a reactant passageway of the fuel cell stack so as to create or impose a fluid head, or sump, within the fluid conduit, which prevents flow into the fuel cell absent activation of the pressure generator. It will be within the ability of the person of ordinary skill in the art, given the benefit of this disclosure, to select suitable dimensions and configurations for the electrolyte delivery apparatus and the components thereof.

In accordance with certain examples, the fluid conduit or conduits that provide fluid communication between the electrolyte reservoir and the fuel cell have suitable shapes and cross-sectional diameters to deliver efficiently electrolyte to the fuel cell from the electrolyte reservoir. Suitable cross-sectional shapes, e.g., circular, for the fluid conduit will be readily selected by the person of ordinary skill in the art given the benefit of this disclosure. In certain other examples, the fluid conduit is generally cylindrical with a length of about 70 cm to about 120 cm and more preferably about 80 cm to about 110 cm. The fluid conduit is typically straight and linear, but, in certain examples, the fluid conduit may be bent, arced or take other form. In certain examples, the fluid conduit has an inside diameter from about 0.005 cm to about 0.10 cm and more preferably about 0.01 cm to about 0.075 cm. In certain examples, the fluid conduit has an outside diameter from about 0.01 cm to about 0.15 cm and more preferably about 0.03 cm to about 0.075 cm. In some examples, the fluid conduit is of sufficient outside diameter or shape so as to be inserted into the reactant passageway of a fuel cell or fuel cell stack. The fluid conduit tube may further comprise a sufficient inside-diameter and length to provide a known flow rate of liquid electrolyte under known pressures and temperatures. In certain other examples, the fluid conduit penetrates the housing of the fuel cell or fuel cell stack and/or the thermal insulation enclosing the fuel cell or fuel cell stack. Suitable materials for the fluid conduit include, but are not limited to, stainless steel, high temperature ceramics, and other materials that can deliver electrolyte and withstand high temperatures, e.g., temperatures around 650° C. or higher. In certain examples, the fluid conduit includes a flow detector to indicate whether or not fluid is flowing through the fluid conduit.

In accordance with certain examples, the electrolyte delivery apparatus also includes a heating device. The heating device is in thermal communication with at least a portion of the electrolyte delivery apparatus and is operative to increase fluidity, or keep fluid, electrolyte in the electrolyte reservoir and/or fluid conduit. In certain examples, the heating device is a heater, e.g., a thermoelectric or resistive heater, a burner, a conventional oven, a microwave oven, etc. In certain examples, a first heater, e.g., an electric resistive heater, is provided along the outer surface of the fluid conduit from the point where the fluid conduit penetrates the fuel cell or fuel cell stack enclosure to the point where the fluid conduit is fluidly coupled to the electrolyte reservoir. The fluid conduit and/or electrolyte reservoir may further include a thermocouple and a controller for measuring and controlling the temperature of the fluid conduit and/or the electrolyte chamber. In some examples, the electrolyte reservoir is provided with a second heater that functions independently of the first heater. The second heater may include a thermocouple and a controller for measuring and controlling the temperature of the electrolyte reservoir. It will be within the ability of the person of ordinary skill in the art, given the benefit of this disclosure, to select and configure suitable heating devices for use in the electrolyte delivery apparatus disclosed here.

In accordance with certain other examples, the electrolyte delivery apparatus can be positioned within a thermally insulated compartment optionally having an oven or other heating device to increase the fluidity of, or keep fluid, electrolyte in the electrolyte reservoir. In certain examples the entire electrolyte delivery apparatus is positioned within the thermally insulated compartment, whereas in other examples, only one of the electrolyte reservoir or fluid conduit is positioned with the thermally insulated compartment. In some examples, the thermally insulated compartment also includes a fuel cell or fuel cell stack, whereas in other examples, the fuel cell or fuel cell stack is positioned external to the compartment containing the electrolyte delivery apparatus.

In accordance with certain examples, the electrolyte delivery apparatus further comprises a pressure generator operative to force fluid out, or in certain examples draw fluid out, of the electrolyte reservoir and into the fuel cell. The pressure generator may be any suitable device that can increase the pressure in the electrolyte reservoir, which results in movement of the fluid out of the electrolyte reservoir, through the fluid conduit and into the fuel cell. In certain examples the pressure generator is a gas, a mechanical piston, or a pressure gradient generator. In at least certain examples, a supply of pressure-regulated gas is used to force fluid out of the electrolyte reservoir and into a fuel cell. In examples where a pressure-regulated gas is used with a molten carbonate fuel cell, a gas such as carbon dioxide can be used to create a high carbon dioxide partial pressure within the reservoir to avoid decomposition of the molten carbonate electrolyte.

In accordance with certain examples, a controller can be used to control the amount of time that electrolyte flows into the fuel cell from the electrolyte delivery apparatus and/or to control the rate of flow. The controller typically includes a microprocessor and a timer or timing circuit that can control the amount of time the pressure generator is activated to force fluid out of the electrolyte reservoir. The controller may also include memory units, suitable software algorithms, suitable sensors, such as temperature sensors, and the like. It will be within the ability of the person of ordinary skill in the art to select and design suitable controllers for use with the electrolyte delivery apparatus disclosed here.

In accordance with certain examples, the electrolyte delivery apparatus is configured for use with a fuel cell or fuel cells in a fuel cell stack. Fuel cells are electrochemical devices that produce direct electric current and thermal energy from a fuel source, for examples, gases such as hydrogen and oxygen. Fuel cell stacks are comprised of a plurality of fuel cells, e.g., planar fuel cells, stacked in a series relationship to achieve higher useable voltage output capacities. Fuel cells within fuel cell stacks are comprised of an anode electrode and a cathode electrode, each applied to the opposing surfaces of an electrolyte membrane, or an electrolyte matrix, commonly referred to as a membrane-electrode-assembly (MEA). MEA's can be combined with a device known as a bipolar plate, also known as a separator plate or an interconnect, that serves as the housing for individual cells of a fuel cell stack. The fuel cell stack may be enclosed by manifolds that direct reactant gases to the housings comprising the bipolar plates for the individual fuel cells. The enclosed fuel cell stack may be further enclosed by thermal insulation for the containment of thermal energy produced by, or delivered to, the fuel cell stack.

Without wishing to be bound by any particular scientific theory, it is believed that the electrolyte is primarily absorbed by the electrolyte matrix and secondarily absorbed by the electrodes due to the smaller pore size provided by the electrolyte matrix. That is, capillary action results in preferential saturation of the fine pores of the electrolyte matrix relative to the larger pores of the electrodes. Generally, at the time of assembly, a sufficient inventory of electrolyte is provided to the fuel cell to achieve the desired saturations of the electrolyte matrix and the electrodes. Again without wishing to be bound by any particular theory, it is believed that over a period of time, the electrolyte inventory is depleted by evaporative loss of the electrolyte, corrosion of the cell hardware, lithiation of the electrodes, general film creepage of the electrolyte over the surfaces of the cell hardware, and/or by voltage driven migration of the electrolyte from one pole of the fuel cell stack to the opposite pole of the fuel cell stack. Generally, the depletion of electrolyte occurs slowly over many thousands of hours of operation of the fuel cell stack. Depletion of the electrolyte inventory below that level necessary to partly saturate the pore volume of the electrodes may result in diminished catalysis and reduced electrochemical performance of the fuel cell. Depletion of the electrolyte inventory below that level necessary to completely saturate the pore volume of the electrolyte matrix can also result in physical mixing, or crossover, of reactant gasses. Crossover is damaging to the fuel cell as it generally may lead to subsequent oxidation of the anode electrode, reduction of the cathode electrode, and combustion-generated hot spots within the fuel cell. Such damage will generally propagate across the fuel cell and will result in premature failure of the fuel cell. To be commercially viable, fuel cell stacks require many thousands of hours of high performance operation, and, therefore, it is desirable to continuously maintain the electrolyte inventory of fuel cells at those levels that result in partly saturated electrodes and completely saturated electrolyte matrices. Excess quantities of electrolyte may be provided to the fuel cell at the point of assembly as is described in U.S. Pat. No. 5,773,161 to Farooque et al., where a reservoir containing excess electrolyte is provided within the void spaces of the bipolar plate that separates adjacent cells of the fuel cell stack. However, this method results in added complexity and cost to the bipolar plate, as well as increased corrosion rates within the void spaces used as the reservoir within the bipolar plate. Furthermore, the reservoir provided in the bipolar plate is finite and can be depleted of electrolyte over time. Methods of adding electrolyte to a molten carbonate fuel cell stack are described in U.S. Pat. No. 4,596,748 to Katz et al., where vaporized electrolyte is “sprayed” into the reactant inlet gas stream entering the fuel cell. This method suffers from the indeterminate nature of the deposition of the electrolyte. Further methods of adding electrolyte to a molten carbonate fuel cell are described in U.S. Pat. No. 4,530,887 to Maru et al., where reactant inlet gas streams are “saturated” with electrolyte. This method also suffers from the indeterminate nature of the deposition of the electrolyte. Physical replenishment of electrolyte to a fuel cell, such as a molten carbonate fuel cell, from sources other than reservoirs within the fuel cell that were created at the point of assembly or by saturation of reactant gas streams has proved difficult. One method of physical replenishment of electrolyte to a molten carbonate fuel cell is to temporarily cease the operation of the fuel cell. The fuel cell is then cooled to ambient temperature, the face of the fuel cell that contains reactant passageways is exposed, and slurries of solidified particles of electrolyte are physically injected into the exposed passageways. The fuel cell is re-sealed and re-heated to above the melting temperature of the fuel cell to melt the electrolyte that was added, and to absorb the melted electrolyte into the porous electrodes and electrolyte matrices of the fuel cell. The aforesaid procedure requires that the fuel cell be brought off-line and shut down, which diminishes the availability of the fuel cell for the purpose of providing usable electrical and thermal energy. In contrast, examples of the electrolyte delivery apparatus disclosed here can be used to replenish electrolyte during operation of the fuel cell or fuel cell stack and without the need to bring the fuel cell or fuel cell stack off-line.

In accordance with certain other examples, electrolyte can be delivered within the reactant passageway of the fuel cell and can be absorbed by the exposed pores of the electrodes associated with the reactant gas passageway. In certain examples, the electrolyte flow rate through the fluid conduit is matched to the electrolyte depletion rate such that the level of electrolyte is substantially constant when the fuel cell is in operation. According to other examples, the electrolyte absorbed by the electrode is distributed throughout the MEA by capillary action within the pores of the components comprising the MEA. In at least certain examples where the electrolyte delivery apparatus is used with a fuel cell stack, the electrolyte may be further distributed to adjacent fuel cells in the fuel cell stack by voltage driven migration through film creepage. In certain other examples, electrolyte may also be further distributed to adjacent fuel cells in the fuel cell stack by voltage driven migration through a dedicated conduit comprising a porous member in contact with each cell of the fuel cell stack. It will be within the ability of the person of ordinary skill in the art, given the benefit of this disclosure, to select and design suitable devices for delivery of electrolyte to different fuel cells in a fuel cell stack.

In accordance with certain examples, fuel cells may be further typified by the physical state of the electrolyte while the fuel cell is in operation. For example, the electrolytes of polymer exchange fuel cells (PEFC's) and solid oxide fuel cells (SOFC's) are generally considered to be solid at operating conditions, while the electrolytes of phosphoric acid fuel cells (PAFC's) and molten carbonate fuel cells (MCFC's) are generally considered to be liquid at operating conditions. Molten carbonate fuel cells are further distinguished from the other types of fuel cells due to the phase change of the electrolyte as the electrolyte and the fuel cell are brought to operating conditions. Molten carbonate fuel cells operate at about 650° C. The electrolyte of molten carbonate fuel cells, such as lithium/potassium electrolyte, is in a solid state at ambient temperature and transitions to a liquid state at operating temperature. Lithium/potassium electrolyte is generally provided in one of the eutectic mixtures such as 62 mol % lithium and 38 mol % potassium that has a melting point of about 493° C. Off-eutectic mixtures of lithium/potassium electrolyte will have a melting temperature other than 493° C. The quantity of electrolyte within a molten carbonate fuel cell is tailored to completely saturate the pore volume of the porous electrolyte matrix in order to achieve separation of the anode and cathode reactant gases within any given cell of a molten carbonate fuel cell stack. Additional electrolyte can be provided to partly saturate the pore volume of the anode and cathode electrodes to improve the catalysis of the electrodes. In accordance with certain examples, and as discussed above, the electrolyte delivery apparatus can be used with molten carbonate fuel cells. In certain examples where the electrolyte delivery apparatus is used with molten carbonate fuel cells, the electrolyte is a liquid solution of lithium, sodium and/or potassium carbonates, soaked in a matrix and the cathode electrode and anode electrode each includes a catalyst such as nickel, copper, platinum, palladium, etc. The electrolyte delivery apparatus can be used to deliver liquid solution of lithium, sodium and/or potassium carbonates to molten carbonate fuel cells to replenish lost electrolyte.

In accordance with certain examples, the electrolyte delivery apparatus can deliver the electrolyte to the fuel cell when the fuel cell is operating or not operating. In certain examples, the electrolyte is typically delivered through a reactant passageway of the fuel cell, e.g., a passageway for introducing reactant gas into the fuel cell.

In accordance with certain other examples, a fuel cell stack is enclosed in a housing and the fuel cell stack includes a plurality of fuel cells wherein each fuel cell has a reactant passageway. A reactant passageway of at least one of the fuel cells of the fuel cell stack is in fluid communication with an electrolyte reservoir by way of a fluid conduit. As discussed above, the electrolyte reservoir contains a supply of electrolyte. In certain examples, at least a first heating device is suitably positioned and operative to heat the fluid conduit. In certain other examples, at least a second heating device is suitably positioned and operative to heat the electrolyte reservoir. In certain examples, the electrolyte in the electrolyte reservoir is forced out by a pressure generator, such as a supply of pressure-regulated gas, for example. In at least certain examples, a flow detector is provided and operative to detect the flow of the pressure-regulated gas used to force electrolyte out of the electrolyte reservoir into the fluid conduit and into the reactant passageway of the fuel cell stack. In accordance with certain examples, the fluid conduit is fluidly coupled with the electrolyte reservoir below the level of the electrolyte contained within the reservoir. In some examples, the fuel cell stack includes a porous member that is operative to distribute electrolyte to other fuel cells in the fuel cell stack. Such porous members include, but are not limited to alumina, zironia and the like. It will be within the ability of the person of ordinary skill in the art, given the benefit of this disclosure, to select these and other porous members for distributing electrolyte to multiple fuel cells in a fuel cell stack.

In accordance with certain other examples, the fuel cell may further comprise thermal insulation, which encloses at least the fuel cell stack, at least a portion of the fluid conduit, and the electrolyte reservoir. In some examples, the fluid conduit and the electrolyte reservoir are dielectrically isolated from the fuel cell stack enclosure to prevent or deter current loss.

In accordance with certain examples, the electrolyte delivery apparatus is used to deliver and replenish electrolyte in a fuel cell or fuel cell stack. For example, upon determining that at least one fuel cell of the fuel cell stack has depleted its supply of electrolyte below that point where optimum catalysis occurs, or below that point where crossover of reactants through the electrolyte matrix occurs, or at any other point determined to be a point of depletion requiring replenishment, the electrolyte delivery apparatus can be activated to supply electrolyte to the fuel cell or fuel cell stack. In at least certain examples, upon activation, the electrolyte reservoir is vented to ambient pressure and heated to a selected operating temperature prior to delivery of any electrolyte. The reservoir can be heated using any one or more of the heating devices discussed above or other suitable heating devices that will be readily selected by the person of ordinary skill in the art, given the benefit of this disclosure. The exact operating temperature will generally depend on the electrolyte to be delivered to the fuel cell. For example, where electrolyte is to be delivered to a molten carbonate fuel cell, the operating temperature is about 650° C.

Upon achieving the reservoir operating temperature, the fluid conduit may be heated to a desired operating temperature, which typically is the same operating temperature used for the electrolyte reservoir, with a heating device. After the operating temperature of the fluid conduit is reached, the reservoir can be pressurized using the pressure generator to force fluid out of the reservoir. In certain examples, the reservoir is pressurized with gas to a known pressure. The rate and amount of electrolyte flow may be pre-determined with experimentation using known pressures, known fluid conduit inside diameters, and known system operating temperatures. In some examples, the electrolyte will continue to flow through the fluid conduit until the reservoir is empty. Once the electrolyte has ceased to flow, the reservoir may be depressurized by venting the reservoir to ambient pressure by opening a vent or valve in the reservoir. In at least certain examples, a timer, e.g. a gas pressure timer, may be activated to maintain the pressure for a selected time prior to venting of the reservoir. The electrolyte will continue to flow until the timer times-out and a controller actuates a valve that controls the flow of pressurized gas and/or vents the reservoir by opening of a vent. In addition, the heating device can be turned off and remaining electrolyte within the reservoir and the fluid conduit can be allowed to cool. In certain examples, a single heating device is used to heat both the electrolyte reservoir and the fluid conduit.

It will be recognized by the person of ordinary skill in the art, given the benefit of this disclosure, that the apparatus and methods disclosed here represents a significant technological advance. Robust apparatus can be assembled to provide intermittent, semi-continuous or continuous addition of electrolyte to operating fuel cells to increase the efficiency of fuel cells. The examples below illustrate only a few of the possible configurations and uses of the electrolyte delivery apparatus disclosed here and should not be interpreted as limiting the scope of the appended claims.

### EXAMPLE 1

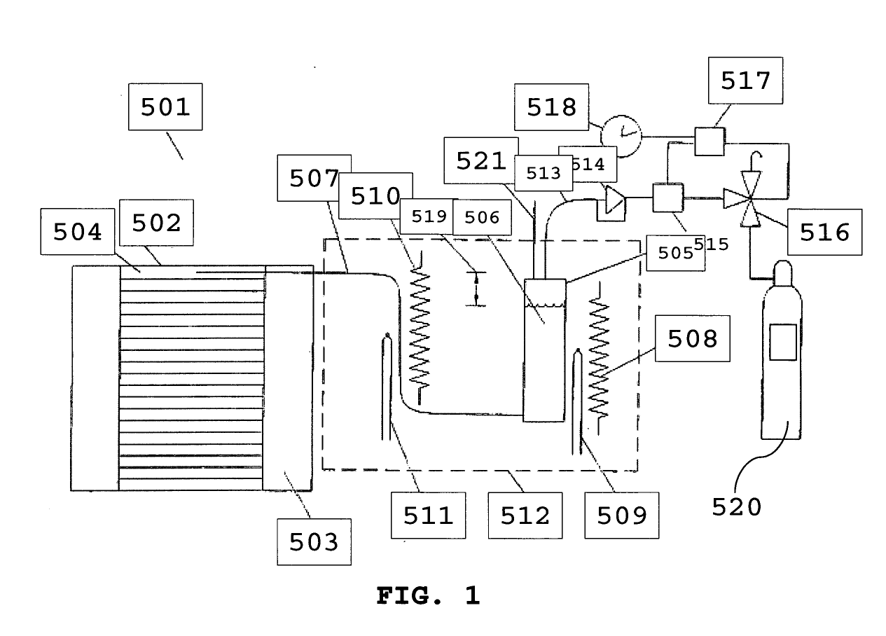

Referring to FIG. 1, a schematic diagram of a fuel cell assembly 501 is shown. A fuel cell 502, e.g., a molten carbonate fuel cell, is provided with a housing 503 and a reactant passageway 504 fluidly coupled to an electrolyte reservoir 505 containing a supply of electrolyte 506 by way of a first fluid conduit 507. The first fluid conduit is fluidly coupled to the reservoir below the level of the supply of electrolyte. Preferably, the first fluid conduit is coupled at a position close to or at the bottom surface of the electrolyte reservoir. The first fluid conduit may be any structure or device capable of fluidly coupling, or providing fluid communication between, the reservoir and the reactant passageway, for example, a tube, a cylinder, or a hose. The first fluid conduit preferably has, for example, an inside diameter ranging from about 0.013 cm (0.005 inches) to about 0.05 cm (0.020 inches) and an outside diameter ranging from about 0.038 cm (0.015 inches) to about 0.076 cm (0.030 inches). The electrolyte reservoir 505 is equipped with a first heater 508 and a thermocouple 509. The first fluid conduit 507 is equipped with a second heater 510 and a thermocouple 511. The electrolyte reservoir 505, and the portion of the first fluid conduit 507 that extends from the housing 503 to the electrolyte reservoir 505, are enclosed by thermal insulation 512. The first and second heaters, as understood here, may be externally mounted electrical resistive heaters, or any other heater or heating device a person of ordinary skill in the art, having the benefit of this disclosure, would deem suitable for their particular purpose. The electrolyte reservoir 505 is further equipped with second fluid conduit 513 fluidly coupled to a pressure regulator 514, a flow detector 515, a valve 516, and a supply of pressurized gas 520. A sump, or pressure head, is created by the elevation 519 of electrolyte reservoir 505 in relation to the reactant passageway 504 in a manner that prevents the outflow of electrolyte 506 from the reservoir 505 to the reactant passageway 504 absent a motive force provided by the supply of pressurized gas 520. A controller 517 controls the actuation of valve 516 and first and second heaters 508, 510. The controller 517 may be programmed to activate valve 516, first and second heaters 508, 510, and timer 518.

During operation of the exemplary device shown in FIG. 1, the electrolyte reservoir 505 is vented to ambient pressure by controller 517, which opens valve 516. The electrolyte reservoir 505 is heated to above the melting point of the electrolyte 506 contained within the electrolyte reservoir, i.e., the electrolyte reservoir operating temperature, by the controller 517 and first heater 508. Upon achieving the electrolyte reservoir operating temperature, first fluid conduit 507 is heated to above the melting point of the electrolyte 506 contained within the electrolyte reservoir 505, i.e., the first fluid conduit operating temperature, by the controller 517 and the second heater 510. Upon achieving the first fluid conduit operating temperature, the electrolyte reservoir 505 is pressurized with a gas 520 such as carbon dioxide to a known pressure by the controller 517 and the gas pressure regulator 514. A gas pressure timer 518 is activated. Upon pressurization of the electrolyte reservoir 505, the liquid electrolyte 506 will begin to flow from electrolyte reservoir 505 through first fluid conduit 507 and into the reactant passageway 504 of fuel cell 502. Liquid electrolyte 506 will continue to flow through first fluid conduit 507 at a rate determined by the pressure of the gas 520 and the inside diameter of first fluid conduit 507 until either the reservoir 505 is empty or until the timer 518 is detected to have timed-out by the controller 518, at which point the controller 518 deactivates the gas pressure regulator 514 to cease pressurization of electrolyte reservoir 505. In the event that the electrolyte 506 flows until electrolyte reservoir 505 is emptied, gas flow detector 515 will detect an elevated gas flow rate and the controller 518 will deactivate gas pressure regulator 514 to cease pressurization of electrolyte reservoir 505. Liquid electrolyte 506 deposited within the reactant gas passageway 504 can be absorbed by the exposed pores of the electrode. The electrolyte flow rate through the first fluid conduit 507 may be matched to the electrolyte depletion rate of the electrode so as to avoid excessive quantities of electrolyte being deposited within the reactant passageway. A person of ordinary skill in the art, having the benefit of this disclosure, will be able to determine the proper rate for their particular purpose. The electrolyte reservoir 505 can be further provided with a replenishment tube 521 through which electrolyte slurry may be injected into the electrolyte reservoir 505 when the electrolyte reservoir 505 requires replenishment of electrolyte 506. The replenishment tube may be capped. Upon replenishment, the heater 508 is energized to raise the temperature of the electrolyte reservoir 505 and replenished electrolyte 506 to drive off the slurry solvent. Slurry solvent may be any solvent known to act as an electrolyte slurry solvent such as alcohol or glycerin, for example. Suitable temperatures for driving off the slurry solvent will be readily selected by the person of ordinary skill in the art, given the benefit of this disclosure, and generally the temperature used depends on the nature and properties of the slurry solvent.

In an exemplary configuration, a fluid conduit having an inside diameter of about 0.025 cm (0.010 inches) and having a length of about 91.4 cm (36.0 inches) provides a flow rate of electrolyte of about 2.0 grams per minute to a molten carbonate fuel cell operating at about 25.4 cm (10.0 inches) of water column above ambient atmospheric pressure at an apparatus temperature of about 650° C. and at an apparatus pressure of about 305 cm (120.0 inches) of water column.

### EXAMPLE 2

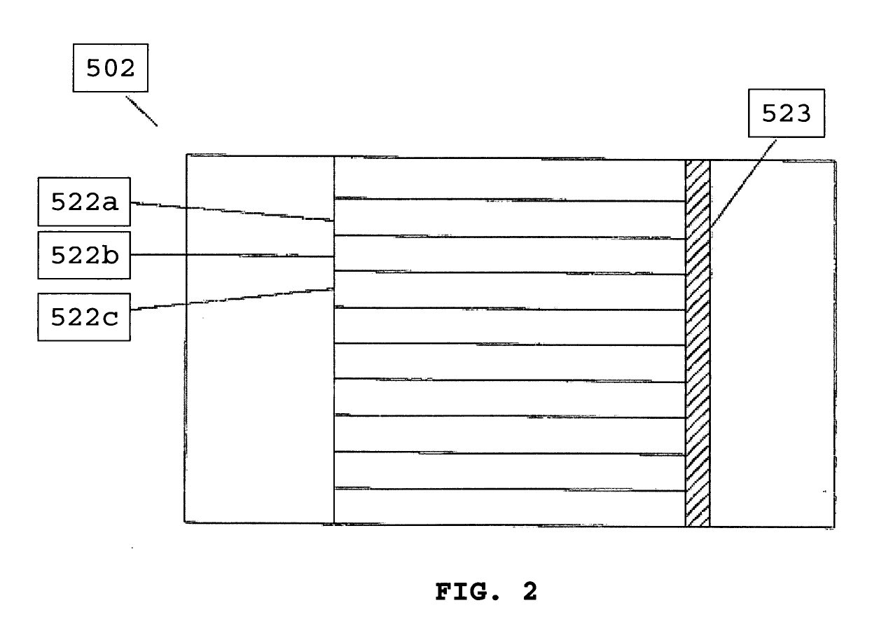

In another example, as shown in FIG. 2, electrolyte may be further distributed to adjacent fuel cells 522a, 522b, and 522c in fuel cell stack 502 by voltage driven migration through film creepage or through dedicated conduit 523 comprising a porous member in contact with each fuel cell 522a, 522b, 522c of the fuel cell stack. The size of dedicated conduit 523 may be selected to provide a particular flow rate of electrolyte 506 that matches the loss-rate of electrolyte of all of the cells of the fuel cell stack 502 such that all of the cells of the fuel cell stack 502 are replenished with electrolyte at a rate equivalent to the depletion rate of electrolyte. Dedicated conduit 523 may comprise pores formed within particles or fibers comprising non-conductive, high-purity zirconia, alumina, or other such ceramics known to be non-conductive and to be inert in the presence of electrolytes, such as, for example, molten carbonate electrolytes. One skilled in the art, given the benefit of this disclosure, will be able to select suitable porous members for including in fuel cell stacks.

While numerous illustrative aspects and examples are described above, it will be recognized by the person of ordinary skill in the art, given the benefit of this disclosure, that alteration, substitutions and modifications of the above exemplary aspects and examples are possible. The person of ordinary skill in the art will also recognize, given the benefit of this disclosure, that certain components of one example may be added or interchanged with certain components of other examples. Such alterations, substitutions, modification and additions are intended to fall within the spirit and scope of the appended claims.

What is claimed is:

1. An electrolyte delivery apparatus comprising:
an electrolyte reservoir comprising electrolyte;
a fluid conduit in fluid communication with the electrolyte reservoir, the fluid conduit configured to receive electrolyte from the electrolyte reservoir;
a heating device in thermal communication with the electrolyte reservoir and the fluid conduit, the heating device being operative to increase fluidity of at least a portion of the electrolyte in the electrolyte reservoir; and
a pressure generator operative to force electrolyte out of the electrolyte reservoir and into the fluid conduit.

2. The electrolyte delivery apparatus of claim 1 in which the heating device is a resistive heater.

3. The electrolyte delivery apparatus of claim 1 in which the pressure generator is a pressure-regulated gas.

4. The electrolyte delivery apparatus of claim 1 in which the fluid conduit comprises a stainless steel tube.

5. The electrolyte delivery apparatus of claim 1 further comprising a vent for venting the electrolyte reservoir.

6. A fuel cell assembly comprising:
a fuel cell comprising a cathode electrode, an anode electrode and an electrolyte matrix between the cathode electrode and anode electrode;
an electrolyte reservoir comprising electrolyte;
a fluid conduit configured to provide fluid communication between the fuel cell and the electrolyte reservoir; and
a heating device in thermal communication with the electrolyte reservoir and operative to increase the fluidity of the electrolyte for delivery to the fuel cell.

7. The fuel cell assembly of claim 6 further comprising a pressure generator configured to force liquid electrolyte from the electrolyte reservoir and into the fuel cell through the fluid conduit.

8. The fuel cell assembly of claim 6 in which the fuel cell is a molten carbonate fuel cell.

9. The fuel cell assembly of claim 6 in which the cathode and anode each comprises a nickel catalyst.

10. The fuel cell assembly of claim 6 in which the heating device is in thermal communication with both the electrolyte reservoir and the fluid conduit.

11. The fuel cell assembly of claim 6 in which the fuel cell is in a fuel cell stack.

12. The fuel cell assembly of claim 6 further comprising a second fluid conduit configured to replenish electrolyte in the electrolyte reservoir.

13. A molten carbonate fuel cell assembly comprising:
a molten carbonate fuel cell comprising a cathode electrode, an anode electrode and a molten carbonate electrolyte matrix between the cathode electrode and the anode electrode;
an electrolyte reservoir comprising molten carbonate electrolyte;
a fluid conduit configured to provide fluid communication between the molten carbonate fuel cell and the electrolyte reservoir;
a heating device operative to heat molten carbonate electrolyte in the electrolyte reservoir; and
a pressure generator comprising a pressurized gas operative to force heated molten carbonate electrolyte out of the electrolyte reservoir.

14. The molten carbonate fuel cell assembly of claim 13 further comprising a thermocouple in thermal communication with the electrolyte reservoir.

15. The molten carbonate fuel cell assembly of claim 13 further comprising a flow detector operative to detect flow of the pressurized gas.

16. The molten carbonate fuel cell assembly of claim 13 further comprising a replenishment tube for adding additional electrolyte to the electrolyte reservoir.

17. The molten carbonate fuel cell assembly of claim 13 further comprising a controller configured to activate the pressure generator.

18. The molten carbonate fuel cell assembly of claim 13 further comprising a timer configured to deactivate the pressure generator after a certain period.

19. A method of supplying electrolyte to a fuel cell, the method comprising:
providing an electrolyte reservoir comprising electrolyte, the electrolyte reservoir in fluid communication with a fuel cell through a fluid conduit;
heating the electrolyte reservoir to increase fluidity of at least a portion of the electrolyte in the electrolyte reservoir; and
delivering electrolyte from the electrolyte reservoir to the fuel cell through the fluid conduit.

20. The method of claim 19 in which the electrolyte is delivered to an operating fuel cell.

21. The method of claim 19 in which the fuel cell is a molten carbonate fuel cell.
